(19) United States
(12) Patent Application Publication
(10) Pub. No.: US 2009/0093925 A1
(43) Pub. Date: Apr. 9, 2009

(54) AUTOMATED CONTROL OF DELIVERY STOP FOR DELIVERY VEHICLES

(75) Inventor: Matthew J. Gumbel, Fort Wayne, IN (US)

Correspondence Address: International Truck Intellectual Property Company,, 4201 WINFIELD ROAD, WARRENVILLE, IL, 60555, US

(73) Assignee: International Truck Intellectual Property Company, LLC, Warrenville, IL (US)

(21) Appl. No.: 11/867,764

(22) Filed: Oct. 5, 2007

(51) Int. Cl. G06F 7/00; G06F 19/00

(52) U.S. Cl. 701/36; 701/29

(57) ABSTRACT

A vehicle electrical system controller is used to monitor selected operating variables, or predetermined operator actions to identify a delivery stop, and upon the vehicle coming to a stop, invoking various vehicle functions to give warning to others that the vehicle is stopped for a delivery, to assist the driver in making the delivery, and, potentially, securing the vehicle during any period the operator is outside of the vehicle.

### BACKGROUND OF THE INVENTION

1. Technical Field

The present invention relates to vehicles and more particularly to commercial vehicles used for local delivery on which the driver/operator is required to take a number of actions, possibly in a partially predetermined order, at each delivery stop.

2. Description of the Problem

When a truck operator makes a delivery stop he or she is often required to perform a number of actions. For example, the operator will be required to bring the vehicle to a stop. If the stop occurs in an area open to vehicular or pedestrian traffic the operator may be required to alert motorists that he/she is about to stop the vehicle. This may be done by activating hazard flashers indicating more than a transitory stop for traffic. Once the vehicle has been brought to a stop it may be required to set the park brake. It may be necessary to illuminate a work or dome light inside the vehicle. An access door to a cargo area may have to be unlocked or opened. It may be further required that the vehicle be turned off before the operator leaves the vehicle. Once the delivery has been completed and the operator has returned to the vehicle it is necessary to undo all of the above to restore the operating condition of the vehicle. It is possible that log entries may be required.

In the past all of these actions had to be done manually, exercising different controls, some of them while the operator was still driving, thus distracting from operating the vehicle. While manual control of most of the sub-systems under consideration is still possible, even probable, changes in vehicle control systems has provided the possibility of automated operation under certain conditions.

Automated sequences of operations stemming from operator actions on a motor vehicle are known. With respect to school buses U.S. Pat. No. 6,396,395 to Zielinski et al., taught a school bus or passenger vehicle in which a driver could operate a single control to operate all of the safety and warning devices. Zielinski taught that the vehicle could be programmed to automatically operate these devices as a function of the vehicle's position relative to programmed stopping points. Zielinski taught that all of the safety and warning devices of the bus were to be in communication with an ESC through a multiplexed vehicle communication system.

### SUMMARY OF THE INVENTION

The invention provides automated handling of some or all of vehicle operations associated with an operator stopping the vehicle to make a delivery of goods or post. Contemporary vehicles are typically equipped with various on board controllers, including at least one relatively general purpose controller which monitors the other onboard controllers. The relatively general purpose controller, here referred to as an electrical system controller, may be programmed to respond to user indication, or the concurrent location of the vehicle at a known delivery point with stopping of the vehicle to invoke one or more functions designed to give warning that the vehicle is stopped and a delivery is in progress. Completion of the delivery may be inferred from operator actions including direct indication from a control provided for operator use. It is also possible to program the system to infer completion of a delivery stop from operator actions inconsistent with the vehicle remaining in place, such as restarting the engine. It will be understood that what is said herein about deliveries from a vehicle can also be said regarding use of the vehicle for picking up shipments. Thus what is termed a “delivery stop” in this application should be taken to mean any relatively brief, non-traffic control related stop made for package handling, either outgoing or incoming with respect to the vehicle. Such packages will typically be small in the sense that they can be conveniently handled by a single person without resort to powered assistance.

Additional effects, features and advantages will be apparent in the written description that follows.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is an illustration of a delivery vehicle.

FIG. 2 is a block diagram schematic of the control system for a vehicle used to implement the invention.

FIG. 3 is a high level flow chart illustrating one of many possible modes of operation of the invention.

### DETAILED DESCRIPTION OF THE INVENTION

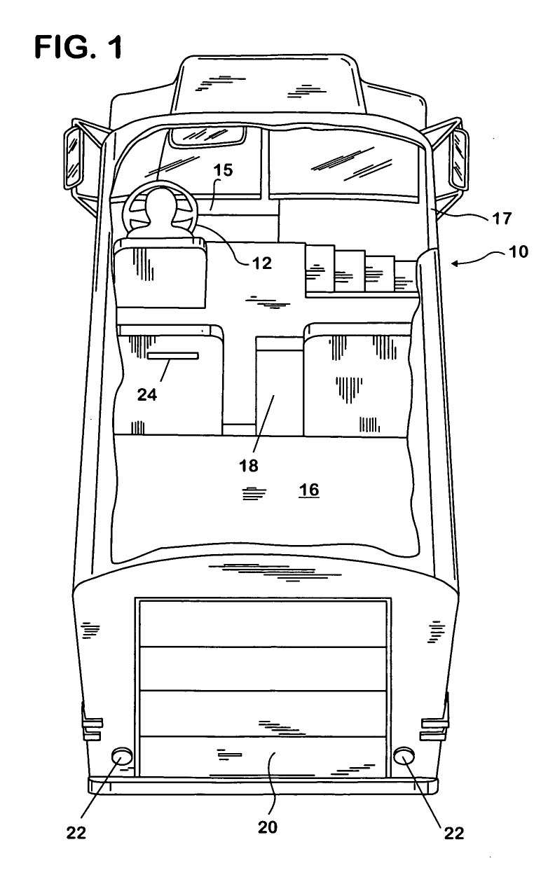

Referring now to the drawings and in particular FIG. 1, a delivery vehicle 10 is illustrated. Delivery vehicle 10 is used to make deliveries, particularly in urban areas, where frequent stops are required. Such stops often occur on streets in heavily trafficked areas. Delivery vehicle 10 is illustrated as a van type vehicle, though the invention could be readily applied to other types of vehicles adapted for delivery purposes. Delivery vehicle 10 is driven by an operator from an operator station 12 located facing an instrument and control panel 15 from which the system of the present invention may be programmed and activated.

Delivery vehicle 10, when halted for a delivery, should be placed in a state which indicates to approaching motorists that it is stopped and not be easily accessible or operated by unauthorized personnel. Vehicle 10 is equipped with a door 17 by which the authorized operator may enter and depart the vehicle. A sensor switch may be used in conjunction with door 17 to indicate whether the door is open or closed. A cargo area 16 may be accessed from the front operator area 12 via a sliding door 18 or a rear tailgate 20. The cargo area may be illuminated by a skylight (not shown) in the roof and/or a work lamp 24 located in the cargo area 16. Lights 22 are shown illustrated at the rear of vehicle 10 which may flash to indicate the vehicle is stopped and poses a potential traffic hazard. Lights (not shown) of like function are located on the front of the vehicle 10. Upon leaving the vehicle 10 via door 17 the system may be programmed to automatically set a park brake if not already set and to shut off the vehicle engine and to restart the engine upon the operator's return. In some embodiments of the invention it should be noted that activating the park brake may be used as a signal that a delivery stop is in progress triggering the other operations required at a stop in sequence. While generally it is anticipated that upon completion of a delivery and return of the operator, the vehicle will return to its operating condition prior to the stop, it is possible to require that the return to operation of some devices, for example starting the engine, be done by the operator. A device for establishing the identity of the operator may be incorporated into the vehicle 10 before the vehicle is released for operation. It should also be noted that the sequence of operations could be tailored for different regular stops depending upon circumstances at each stop. A default set of responses could be

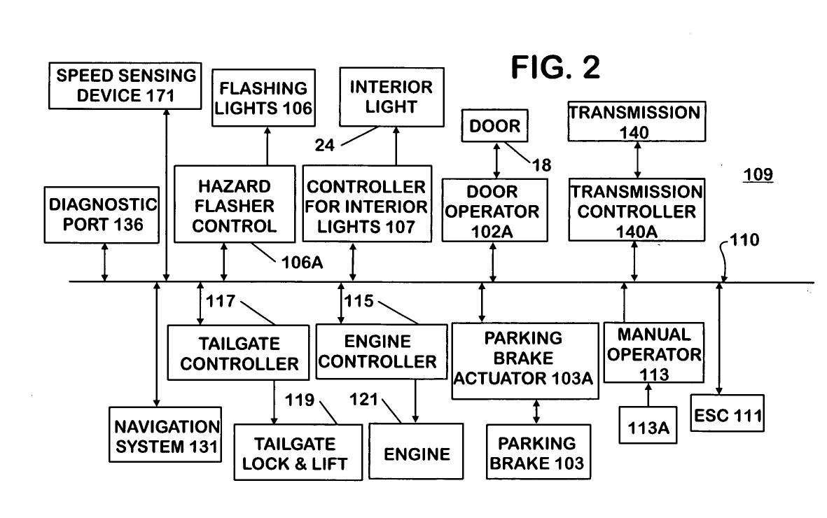

Referring particularly to FIG. 2, a block diagram schematic of a control system 109 for vehicle 10 illustrates operation of the invention at the physical level. Control system 109 represents a possible control system in which most major functions relating to the invention have been illustrated as located with individual controllers for execution. Control system 109 includes an electrical system controller (ESC) 111, or equivalent, which may be taken to serve as a supervisory controller over the control system. ESC 111 and other controllers communicate with each over a bus 110, which operates in accord with a protocol such as the Society of Automotive Engineers (SAE) J1939 protocol relating to controller area networks (CAN). The controllers may be dedicated controllers, such as engine controller 115, or they may be generic controllers which are programmed to carry out particular operations. The assignee markets generic controllers for controller area network applications, termed Remote Power Modules, which can be readily programmed from an external diagnostic port 136 or by the electrical system controller 111 in response to particular hardware attached to the remote power module. In an SAE J1939 CAN context, data buses may be private or public. Data bus 110, in an SAE J1939 context, may be a taken to be a conflation of a public and private bus. A system topology will generally provide that the generic controllers are connected to the private bus and the dedicated controllers are connected to the public bus. The ESC 111 is connected to both buses and acts as a bridge between the buses. The general principal here is that generic controllers are typically used to provide customer specific functions, and use an customized communication set, which is not understandable by the dedicated controllers, requiring the ESC 111 to handle translation, where required before data is exchanged between dedicated and generic controllers.

The common data bus 110 may be a serial data bus or link 110. The autonomous controllers or operators may include local data processing and programming and are typically supplied by the manufacturer of the controlled component. The serial data link 110 may be a twisted pair cable constructed in accordance with SAE standard J1939 and may be externally accessible via a diagnostic port 136. Although the autonomous controllers handle many functions locally and are functionally difficult without reference to ESC 111, they report data to ESC 111 and can receive operational requests from ESC 111.

Typically any function which can be carried out by a generic controller may also be carried out by the electrical system controller (ESC) 111, provided output ports are available for connection of operational hardware to the ESC. An example of functions which might be placed with a generic controller or placed with the ESC 111 is provided by a tailgate controller 117, which provides the functions of locking, unlocking, raising and lowering of a tailgate 20 through a tailgate lock and lift device 119. Thus tailgate controller 117 may be programming on ESC 111, or a programmed generic controller which ESC 111 communicates with over bus 110. A tailgate controller 117 would be expected to be a programmed generic controller while the functions of an interior lighting controller 107 would more typically be expected to be under the direct control of ESC 111 or, possibly, a dedicated gauge and instrument controller (not shown).

An exemplary, substantially automated delivery stop routine, as implemented under one embodiment of the invention, may now be considered. The vehicle 10 is illustrated having a sensed parameter measurement device such as a speed sensing device 121, which provides a signal indicating the vehicle's speed. A navigation system 131 provides the geographic location of the vehicle 10. The navigation system is conventionally supplied by a Global Positioning System (GPS) device that takes an external input from a satellite such as the commercially available LORAN system. The navigation system 131 may alternatively be a dead reckoning system without an external input or a combination of an external system and an internal to the vehicle 10 dead reckoning system from the speed sensing device and other sensed parameter measurement devices.

Basic operations typically include providing for activation of safety and warning devices in response to delivery vehicle 10 stopping for a delivery. Such a “delivery stop” is to be distinguished from a routine traffic stop in that some operation beyond illuminating the stop lights is carried out. Where the process is fully automated this includes recognition by ESC 111 that a stop is for delivery or pickup of a package. In some applications delivery stops will occur only at certain predetermined geographic locations, which may be programmed in ESC 111 along with a route. Where the delivery vehicle 10 has followed the route and where it has slowed and stopped at or near a programmed location, the system responds as provided for a delivery stop. The operating variable of vehicle position will be immanent to the delivery stop, that is, will always occur within the occasion of such a stop. The appropriate functions are invoked unless cancelled by the driver. Alternatively, delivery vehicle 10 may be provided that a manually controlled switch 113 provides for execution of a delivery stop routine by control system 109.

The ESC 111 may be programmed to operate all, one, or some of the devices used for securing the operators safety and for warning approaching motorists. The control system 109 is armed to execute a delivery stop sequence in response to the operator's use of the manual operator 113 located in a convenient location for the driver. The manual operator 113 contains a button or switch or lever 113A that the driver may operate for this purpose and is connected to the data bus 110 to communicate the event to the ESC 111. In an automated scheme the subsequent occurrence of a sequence of initiating events results in the invocation of the delivery stop functions. The ESC 111 invokes the functions based upon one or more sensed dynamic operating variables/parameters, such as speed and location, which are selected as indicative of a delivery stop. Upon the vehicle stopping the ESC 111 can instruct: the dedicated transmission controller 140A to place the transmission 140 into neutral (or take it of gear); the parking brake actuator 103A to set the parking brake 103; the door operator 102A to open a door (17 or 18); a hazard flasher controller 106A to initiate flashing of external lights 106; an interior lights controller 107 to illuminate appropriate interior lights 24; and a tailgate controller 117 to operate a tailgate lock and lift mechanism 119. Upon the operator leaving the vehicle the engine controller 115 might be instructed to kill the engine 121 and the transmission controller 140A to lock the transmission 140 with engine 121 shut off by moving the transmission 140 to reverse. It will be understood that the initiating conditions and responses are flexible being limited only by the imagination of the operators and reasonable prudence.

The process is reversed in response to an action taken by the operator unambiguously indicating completion of delivery, such as manual release of the parking brake 103, or depression of a brake foot pedal (not shown). In such a case the ESC 111 will cancel the prior instructions.

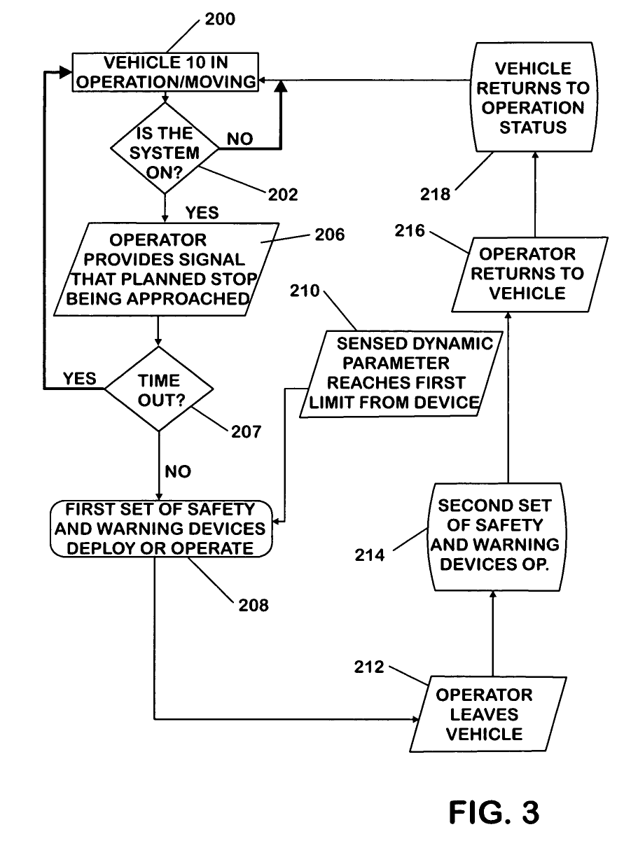

The system can be represented as a looping routine as depicted in FIG. 3. At step 200 the vehicle 10 is indicated as being in operation. Next, a decision step 202 indicates a determination is made as to whether automated delivery stop functionality has been activated. If NO, the routine loops back to step 200. If YES, step 206 indicates when an indication is generated that a delivery stop is impending. Here it is assumed that operation is not fully automatic, but that the operator provides a positive indication that a stop is pending. Alternatively at step 206, preprogrammed indicators may indicate a pending stop. Step 207 provides an upper limit to the period of time which the system will allow for a stop to occur without cancelling the indication from step 206 and returning to step 200. If the stop does occur within the time limit, step 208 is executed. The stop is indicated by a “sensed dynamic parameter” (e.g. the vehicle comes to a stop) detected at step 210 and in response thereto a first set of delivery stop functionalities are invoked (step 208). These may include activation of hazard flashers 106. Next, step 212 indicates the operator leaving the vehicle. At step 214 a second set of safety and warning devices is invoked, such as shutting down the engine 121 and locking the transmission 140. Return of the operator to the vehicle 216 may be indicated by automatic detection, secured detection, or the operator's use of a vehicle control to indicate readiness to resume travel. At step 218 the first and second set of warning and safety devices are turned off to allow resumption of travel.

While the invention is shown in only one of its forms, it is not thus limited but is susceptible to various changes and modifications without departing from the spirit and scope of the invention.

What is claimed is:

1. A vehicle system for automated operation of vehicle sub-systems at delivery stops, the vehicle system comprising:
a vehicle system bus;
an electrical system controller connected to the vehicle system bus;
a plurality of controllers connected to the vehicle system bus for communication of data with the electrical system controller, said data including readings for at least a first vehicle operating variable and the plurality of controllers being responsive to instructions generated by the electrical system controller; and
a plurality of vehicle sub-systems under the control one or more of the controllers or the electrical system controller, the electrical system controller being programmed to invoke operation of a vehicle sub-system used during a delivery stop in response to data identified as immanent of occurrence of a delivery stop.

2. A vehicle system in accordance with claim 1, wherein said at least first vehicle subsystem is an external warning system installed on the vehicle for operation during a delivery stop, and the electrical system controller is programmed to respond to said at least first vehicle operating variable for invoking operation of said at least first external warning system.

3. A vehicle system in accord with claim 2, further comprising:
the electrical system controller being further programmed to respond to an active user indication in invoking operation of said at least first external warning system.

4. A vehicle system in accord with claim 3, wherein the active user indication is indication of immanency of a delivery stop and the vehicle operating variable is vehicle speed.

5. A vehicle system in accord with claim 3, wherein the active user indication provides for arming the vehicle system and vehicle operating variables include vehicle location and vehicle speed.

6. A vehicle system in accord with claim 3, further comprising:
the electrical system controller being further programmed to respond to an operator generated indication that the delivery stop is complete for restoring the vehicle to an operational condition as it existed prior to invocation of the first external warning system.

7. A vehicle system in accord with claim 4, further comprising:
the electrical system controller being programmed to respond to operator egress from the delivery vehicle to invoke a second set of warning and safety functions for securing the delivery vehicle.

8. A vehicle system in accord with claim 3, further comprising:
the electrical system controller being programmed to respond to the vehicle stopping for invoking delivery vehicle functions supporting handling of deliveries or pickups of shipments.

9. A vehicle system in accord with claim 7, further comprising:
the electrical system controller being further programmed to respond to an operator generated indication that the delivery stop is complete for restoring the vehicle to an operational condition as it existed prior to invocation of the first external warning system.

10. A vehicle system in accord with claim 8, further comprising:
the electrical system controller being further programmed to respond to an operator generated indication that the delivery stop is complete for restoring the vehicle to an operational condition as it existed prior to invocation of the first external warning system.
